(19) United States
(12) Patent Application Publication
(10) Pub. No.: US 2013/0030677 A1
(43) Pub. Date: Jan. 31, 2013

(54) DRIVE SYSTEM WITH AN APPARATUS FOR INTERRUPTING THE OPERATION IN THE CASE OF AN IMMINENT LACK OF OPERATING MEDIUM

(71) Applicant: Michael Steffen, Munich (DE)

(72) Inventor: Michael Steffen, Munich (DE)

(73) Assignee: Wacker Neuson Produktion GmbH & Co. KG, Munich (DE)

(21) Appl. No.: 13/520,439

(22) PCT Filed: Mar. 7, 2011
(86) PCT No.: PCT/EP2011/001110

§ 371 Date: Jul. 3, 2012

(30) Foreign Application Priority Data
Mar. 9, 2010 (DE) 10 2010 010 749.2

(51) Int. Cl. G06F 19/00

(52) U.S. Cl. 701/112

(57) ABSTRACT

A drive system has an engine, a tank container for storing an expendable operating medium for the engine, a filling-level monitoring apparatus for monitoring the filling level in the tank container and/or in a feed line from the tank container to the engine, and an interruption apparatus for interrupting the engine in the case of an imminent lack of operating medium. If the filling level drops below a predefined filling-level height, this is detected by the filling-level monitoring apparatus and reported to the interruption apparatus which thereupon interrupts the drive system. Drive systems which are designed in this way are suitable for use in equipment, for example, in civil engineering, where emptying of the fuel tank frequently occurs as a result of the extreme building-site operation.

### BACKGROUND OF THE INVENTION

1. Field of the Invention

The present invention relates to a drive system having monitoring of the filling level of a tank container for storing an expendable operating medium, and to a tool having such a drive system.

2. Discussion of the Related Art

In order to function correctly, drive systems having an engine require expendable operating media such as fuel in order to drive the internal combustion engine. Such expendable operating media can be stored in tanks that are connected to the engine via a feed line system.

During use of such a drive system, due to limited tank volume the tank container or the feed line system may become empty. This can cause material damage to the drive system, and air may enter into the feed line system.

In internal combustion engines, simple filling level monitoring systems are used for the operating medium tanks in order to indicate the filling level to an operator of the system. Thus, when a lack of operating medium is imminent, a signal can be outputted in order to inform the operator of this situation. In addition, from oil state monitoring technology, devices are known that interrupt the engine or prevent starting of the engine when there is a lack of oil in the crankcase of the engine.

DE 10 2004 021 394 B4 indicates a tool having an internal combustion engine that has a starter device, an oil reservoir in the area of the crankcase, an oil measurement device for recognizing whether oil is present in the oil reservoir, and an evaluation device for producing an item of oil state information. This item of oil state information can be produced in a particular period of time after the starting of the internal combustion engine. If a lack of oil in the crankcase is recognized during this period of time, the ignition of the internal combustion engine is prevented by a stop device.

EP 1 818 519 A2 indicates a control device for a multi-purpose engine having a control unit for switching on and off the supply of energy to an ignition circuit. The switching takes place on the basis of two states, namely the operating state of the multipurpose engine determined on the basis of a recognition signal of an engine speed sensor, and the state of filling of an oil supply, determined on the basis of a recognition signal of an oil filling level sensor of a float type.

US 207/079793 A1 indicates a system and a method for avoiding injection failures in a fuel injection system of a diesel engine of a motor vehicle. During engine operation, a monitoring system stops the engine when a sensor of the fuel level signals that there is a risk of injection failure because the tank does not contain an adequate quantity of fuel. In a specific embodiment, the engine cannot be restarted before additional fuel has not [sic] been added. A further feature permits restarting of the engine and limited running time after the interruption.

EP 1 302 632 A1 indicates the fuel supply system for an engine having a fuel tank, a fuel injector, an injection pump having an inlet connected to the fuel tank by an inlet line, and an outlet connected to the fuel injector by a supply line. In addition, an engine interruption device is provided that can interrupt the engine when a filling level of the lubricant oil in an oil sump of the engine is below a desired minimum level.

EP 0 420 421 A2 indicates a liquid sensing device that detects a liquid level in a container. The device has a capacitive reference sensor for detecting the dielectric constant of the liquid and a capacitive filling level sensor for detecting the filling level of the liquid. A housing forms a capacitor plate, and two separately wound wires form two capacitor plates. The capacitive reference sensor is situated on an upper end, at an inlet. The capacitive filling level sensor is situated in a lower segment of the housing in order to detect the filling level in the container.

FR 2 681 424 A1 indicates a detection device for a liquid level. The detection device has a probe having an essentially cylindrical electrode that is coated with a dielectric artificial resin, and has an outer electrode that surrounds the cylindrical electrode. The probe can be introduced into the liquid essentially vertically, in such a way that the liquid can penetrate between the center electrode and the outer electrode. In addition, an electronic switching circuit is indicated for deriving the liquid level from the measured capacitance of the probe.

GB 2 055 477 A indicates an electrostatic fuel measuring device having a pair of electrodes situated opposite one another, separated by insulating spacing elements. The electrodes can be introduced into the liquid gasoline in a tank, and a change in the electrostatic capacitance between the electrodes due to a change in the filling level of the fuel is recognized electrically. The fuel quantity can be measured and displayed.

However, in the operation of engines impairments in the operation of the drive system may occur in situations other than a lack of oil. Thus, functional impairments occur when, given a lack of fuel in an internal combustion engine, the feed line system from the fuel tank to the engine, or a carburetor that is present, draws air. In this case, the feed line system and the carburetor must first be vented before the drive system can be started again. For this purpose, many start attempts are usually necessary after a refilling of the tank container.

### SUMMARY OF THE INVENTION

The present invention is based on the object of indicating a drive system for a tool having an engine that automatically interrupts the engine when there is an imminent lack of expendable operating media, so that a running empty of the feed line system from the tank container to the engine and of the engine itself, as well as the penetration of air, are effectively prevented.

A drive system has an engine and a separate tank container for storing expendable operating media for the engine. In addition, a filling level monitoring device is present that enables monitoring of the filling level in the tank container and/or in the feed lines between the tank container and the engine. In addition, an interruption device is provided with the aid of which the operation of the engine can be interrupted when the filling level monitoring device has determined that the filling level has sunk below a predetermined filling level.

Depending on the use of the drive system, the engine can be a steam turbine or a gas turbine or an internal combustion engine. The internal combustion engine may be a diesel engine or a gasoline engine that operates according to a two-stroke or four-stroke design.

Depending on their design, these engines require different operating media. Thus, non-expendable operating media such as lubricants are used that, by lubricating the mechanical moving parts of the engine, can reduce friction and wear, improve transmission of force, and seal openings. Because, as already mentioned, the filling level of lubricant can be monitored using already-known devices, such a filling level monitoring is not the subject matter of the following statements.

Internal combustion engines require, as an essential expendable operating medium, fuel that has a high energy density and that is combusted in order to drive the mechanical system. As a fuel, for example gasoline or diesel fuel is used. Such an expendable operating medium can be stored in separate tank containers and supplied to the engine via a feed line system. Because here rapid emptying is common, a running empty of the tank container and of the feed line system to the engine can easily occur.

In addition to the separate storage of fuel, it is also known to store a gasoline-oil mixture as used in two-stroke engines. Such a gasoline-oil mixture can be stored in a separate tank container. Because such a mixture is rapidly consumed during operation of the engine, here a filling level monitoring can be carried out using a filling level monitoring device, so that impairment of operation by running empty of the engine and of the feed line system is prevented.

In the case of a separate lubrication, the oil can in contrast be drawn either from a separate tank container or from an oil reservoir in the vicinity of the crankcase. In this case, only the fuel, which is then stored in a separate tank container, is subject to rapid consumption, which can be monitored by the filling level monitoring device. Monitoring of the filling level in the oil reservoir can be carried out using a standard oil level monitoring device.

The tank container is made up of a container for filling with the expendable operating medium, having a feed line for supplying the operating medium to the engine, e.g. to the carburetor. Because the operating medium, once it has been conducted out of the tank container and to the engine, is consumed and is not conducted back into the tank container, the operating medium contained in the operating medium tank is always unconsumed and can be supplied to the engine with constant quality.

This stands in contrast to the oil sump lubrication that is standard for oil, in which the oil is stored in an oil pan (oil sump) integrated into the crank chamber. In oil sump lubrication, during operation of the engine consumed oil flows back into the oil reservoir, so that the oil supply is essentially maintained, but the quality of the stored oil decreases as use progresses.

Depending on the type of operating medium and the shape of the operating medium tank, different devices are used for filling level monitoring. For fuel monitoring, float systems are used in which a float is attached in the tank and the filling level information is derived from the position of the float. In addition, filling level measurements using measurement rods or pressure switches are known.

The use of the filling level information differs according to the use of the drive system and the type of fuel. For example, the operator can be informed about a filling level recognized by the filling level monitoring device or about a lack of operating medium. The information can be reported for example by a signal. A light signal can for example be indicated via a light-emitting diode, an acoustic signal can be emitted for example via a buzzer, and/or a message can for example be presented as text in a display. The display can be constructed or controlled in such a way that a users choice regarding the language that is to be used is evaluated and supported.

The signaling can take different forms depending on the filling level. Thus, when the level falls below a predetermined first filling level that may be low but not yet critical, an indication can for example be made by a weak and/or continuous light signal, a weak and/or intermittent acoustic signal, and/or a corresponding text message, for example “fuel reserve.” Interruption of the drive by the interrupting device may at this time not yet take place. The operator can then refill the tank container at a suitable time. When the level falls below a second predetermined filling level, which can be lower than the first predetermined filling level, a further item of information can be outputted, for example by a blinking light signal, a strong and/or continuous acoustic signal, and/or a further text such as “low fuel reserve—please refuel now.” This makes it possible for the operator to take suitable measures for switching off the drive system, such as looking for a park position. In addition, when the filling level falls below a third, possibly still lower, predetermined level, the operation of the engine can be interrupted by the interruption device and a corresponding signal can be outputted to the operator, for example by controlling a colored or red light-emitting diode, an additional, loud acoustic signal, and/or through the output of a corresponding text, such as “shutoff due to lack of fuel.” The message may remain visible to the operator past the time of interruption.

Also possible is a continuous displaying of the filling level during a period of operation of the drive system, by a display device provided for this purpose.

The interruption device makes it possible, additionally or alternatively to these possibilities for monitoring the filling level of the tank container, to provide interruption of the drive system or of the engine if the filling level in one or more tank containers falls below a predefined filling level.

Switching off the engine when there is an imminent lack of fuel can prevent the feed lines between the fuel tank and the engine from drawing air, or can prevent air from entering into a carburetor provided in the internal combustion engine. This represents an advantage over conventional systems that in this case have to be laboriously vented, with many start attempts, when there is a restart.

In addition, a low filling level in the tank container can be recognized already at the beginning of the operation of the drive, for example before a starting of the engine. In this case, the starting of the engine can be prevented from the outset by the interruption device. An item of information regarding the filling level, for example in the form described above, can be outputted. Alternatively, the engine can be started, if the filling level permits this, and can be operated over a predefined time span or as long as the filling level permits. This makes it possible for the operator to move the drive system for example to a suitable parking position or refueling position.

The interruption of the drive system can for example be achieved through the action of the interruption device on an ignition device of the engine. For example, the introduction of an ignition impulse to a spark plug can be prevented. If the internal combustion engine is a self-igniting engine, such as a diesel engine, it is alternatively possible to prevent the supply of fuel by controlling an electronic valve.

The detection of an imminent lack of an expendable operating medium by the filling level monitoring device can take place in various ways via a determination of the filling level.

Thus, it is conceivable for the filling level monitoring device to report the imminent lack to the interruption device as late as possible, so that the engine can be operated as long as possible, and only serious consequences of the lack of operating medium, such as the penetration of air into the feed line between the tank and the engine, are prevented.

Alternatively, the specification of a higher filling level is possible, so that the imminent lack of fuel is recognized earlier by the filling level monitoring device and/or, as already described above, can be reported to the operator. In this case, a short span of time may elapse until the switching off of the engine without disadvantageous consequences of the lack of fuel causing damages or serious impairments. The definition of the filling level and the specification of the span of time until the automatic shutoff by the interruption device can in this case be suitably matched to one another.

As already stated, it is possible to predefine a plurality of filling levels reported by the filling level monitoring device. Thus, when a lack of operating medium becomes apparent, an early item of information can be outputted to the user. If the filling level has sunk lower, emergency measures can be introduced and a suitable point in time for the shutoff can be sought. A direct shutting off of the engine by the interruption unit can be carried out only when a very low filling level has been reached below which disadvantageous consequences would result for the entire drive system or operated tool. In addition to this step-by-step reaction, the present filling state in a tank container can be continuously outputted and made visible to the user.

In the case of such a controlled shutoff, in contrast to the conventional running empty of the engine it is possible to influence the time of the shutoff. Thus, if the interruption device is provided with information concerning an imminent lack of fuel and a period of time for the shutting off of the engine is predefined, the interruption device can first initiate emergency measures. Such emergency measures can have the aim of bringing the drive system or tool operated by the drive system into a safe state, for example by opening pressure valves that may be present or ensuring that movable parts of the tool are in a rest position. In addition, for the shutting off of the engine an operating state can be sought in which stoppage of the system is advantageous. This is possible for example if the drive system is used in a tool that operates periodically, such as a press in a pressing plant. Here, before the shutting off of the drive unit the operating state can be sought in which the press is retracted and the workpiece can easily be removed. In this way, an abrupt interruption of the drive, caused by a lack of fuel, in an unfavorable state of the tool can be avoided.

Depending on the type of operating media to be stored, different types of tank containers may be present in the drive system. Thus, if an internal combustion engine is used, the fuel can be stored in a fuel tank. If a mixed lubrication is used, a fuel-oil mixture is stored in a tank provided for that purpose. In addition, the use of a plurality of tanks, for example a main tank and a reserve tank, is possible. All of these variants and combinations can be provided in a drive system corresponding to the present invention and can be subjected to monitoring.

If a drive system has a plurality of tank containers, there are various possibilities for monitoring the filling level. Thus, it is possible to provide a separate filling level monitoring device for each individual tank container. It is also possible for a filling level monitoring device to monitor a plurality of tank containers. Each filling level monitoring device that is present can provide information to the interruption device concerning an imminent lack of operating media. Thus, when there is a low filling level in one or more tank containers, a shutoff of the engine can be carried out.

Due to the close cooperation of the filling level monitoring device and the interruption device, in a variant of the present invention these can be completely or partly integrated and can be realized using common components. A realization is possible in which only the sensor system of the filling level monitoring device is situated separately, while all other parts of the filling level monitoring device and of the interruption device are realized using common components.

A variant of the present invention having an internal combustion engine has an ignition device for igniting a compressed fuel-air mixture in the combustion chamber of a cylinder. This can be a magnetic ignition, an interrupter ignition, or an electronically controlled ignition. In this variant, the interruption device can interrupt the operation of the engine by preventing further ignition of the ignition device.

The close cooperation of the interruption device and the ignition device makes it possible to completely or partly integrate both devices in a variant of the present invention. The filling level monitoring device can also be completely or partly realized in common with the ignition device or with the integrated interruption and ignition device, so that the components used form a unit and can be installed together into the drive system.

In a specific embodiment of the present invention, the drive system has a device for producing and/or storing electrical energy. This can be a magnetic ignition system that produces energy or can be a battery ignition system capable of storing energy. A generator for producing energy can also be integrated in the drive system. In addition, the storage and provision of energy can be accomplished by a battery or an accumulator. The energy provided in this way can now be used to operate the filling level monitoring device and/or the interruption device.

If the magnetic ignition system is used to supply energy, no additional component need be provided. The filling level monitoring device and/or the interruption device can then first be supplied with energy after the starting of the engine. If the filling level information is evaluated already before the starting of the engine, in addition a battery or an accumulator can be used. In this case, a starting of the engine can be prevented from the outset when the filling level of one of the operating media is insufficient.

In a further variant embodiment, a sensor is provided for monitoring the filling level of the tank container. Such a sensor can be situated on or in a tank container or also on or in the feed line from the tank container to the engine. It can operate according to various principles; suitable designs include capacitive, optical, thermal, and/or mechanical measurement designs.

The selection of the measurement design can be made with regard to the area of use of the drive system. Thus, given use in a tool in which the drive system or parts thereof are subjected to accelerations, a secure measurement of the filling level in the tank containers is not reliably possible using mechanical systems, for example float systems. This is true for example of tampers or vibrating plates for soil compaction, and of drill or impact hammers. In motor vehicles, in particular in the starting phase accelerations cause turbulence in the tank containers that makes it more difficult to determine the filling level using conventional float systems. Even when the drive system is operated in different spatial positions, as is the case for example in smaller tools such as power saws or lawnmowers, measurement using float systems is often not reliable. In these cases, a capacitive, optical, magnetic, or thermal measurement can enable indication of the filling level of the tank container.

In a variant of the drive system, the sensor of the filling level monitoring device operates on a capacitive basis and has two electrodes that are positioned in or on the tank container or in or on the feed line system in such a way that when the filling level is adequate the operating medium is situated between the capacitor electrodes, where it acts as a dielectric. Depending on the filling level, in this way the capacitance of the capacitor is modulated, and this capacitance is evaluated using an oscillating circuit, thus permitting the filling level in the tank to be inferred.

In a further variant of the present invention, the sensor is positioned as deep as possible in the tank container, relative to a higher level during the use as intended of the drive system. In this way, a long operating duration of the drive and a substantial emptying of the tank container can be achieved before the interruption device stops the operation of the engine due to an imminent lack of operating medium.

It is also conceivable to situate the sensor on or in the feed line system between the tank container and the engine. Here care must be taken that the segment of the feed line from the position of the sensor up to the tank container has a continuous incline relative to the height level during the use as intended of the drive system, said incline enabling air bubbles of the air penetrating up to that point in the case of emptying to rise up when the tank is refilled. In this way, it is ensured that only as much air can penetrate into the tank container and into the feed line from the tank container to the engine as can automatically escape when the tank is refilled. At the same time, a long operating time of the engine is enabled.

Such a configuration is suitable for monitoring a fuel tank or a combined fuel-oil tank, because in this way the feed lines and/or a carburetor that is present, or alternatively an injection system, are prevented from drawing air. These must otherwise first be vented before the drive system is restarted, which in general entails a good deal of effort and many start attempts.

In a further specific embodiment of the drive system having a capacitive sensor, a measurement container can be provided. The measurement container can be connected by an inlet to a first part of the feed line upstream, and can be connected by an outlet to a second part of the feed line downstream. The operating medium conducted from the tank container to the engine can in this case be guided through the first part of the feed line and the inlet into the measurement container and through this container, and subsequently can be guided through the outlet and through the second part of the feed line to the engine, so that when the operating medium is conducted from the tank container to the engine it flows through the measurement container.

In this specific embodiment, the electrodes can be situated as separate components in or on the measurement container, or can form a constructive unit therewith. The capacitance between the electrodes is modulated in accordance with the filling level of the measurement container, enabling electronic evaluation of the filling level.

In a variant of this specific embodiment, at least one of the electrodes can be a component of a wall that surrounds the measurement container. For example, the electrodes can be formed by two wall regions of the measurement container that are electrically insulated from one another. In this way, the electrodes can be situated so as to save space and in stable connection to the measurement container.

The wall areas that form the electrodes can be situated along a sectional line that leads through the measurement container, stacked at least two layers. In other words, the wall regions can be folded into one another in such a way that an alternating layering of the two wall regions or electrodes results, having spatial overlapping. In this way, the capacitor surfaces separated by the dielectric and situated opposite one another can be enlarged, which guarantees a suitable degree of sensitivity of the capacitive sensor with slight spatial expansion of the measurement container.

In addition, in such a construction of the measurement container the interlocking of the wall regions results in a small filling volume that extends over a multiply angled region. In this way, for example a lack of sensitivity of the capacitive sensor to turbulence in the operating medium in the measurement container is achieved, which turbulence can occur if the drive system, for example in a tool, is exposed to strong shaking or vibrations.

In a variant, the measurement container can be provided as an integral component of the feed line, i.e. can be constructively integrated into the feed line. In this specific embodiment, the electrodes of the capacitive sensor can be situated in or on the measurement container.

In a further variant, a measurement container can be integrated completely or partly into the filling level monitoring device and/or the interruption device. This is for example possible if, due to the stacked configuration of the wall regions, a measurement container is achieved having a small volume and small spatial dimensions while simultaneously having sufficient measurement precision. Through the integration of the measurement container into the filling level monitoring device and/or the interruption device in a module, a simple electrical connection of the named components is possible, so that the wiring outlay is minimized. At the same time, weak spots in the wiring are avoided that could be a possible source of malfunctions. This is advantageous with regard to the use of the drive system in a tool that is exposed to shaking and vibrations.

In addition, a plurality of measurement containers of the above-described types can be combined with one another, with the filling level monitoring device, and/or with the interruption device to form an assembly. Here, the several measurement containers can for example be configured one after the other, for example as components of a single feed line. This enables a precise and, if warranted, step-by-step evaluation of the filling level of the tank container. Alternatively or in addition, the measurement containers can each be connected to a plurality of feed lines, e.g. of a plurality of tank containers. This enables an evaluation of the filling level of a plurality of tank containers with, if warranted, a plurality of different expendable operating media.

A drive system corresponding to the present invention can be used in various tools. In particular, such a drive system can be used in tools in which a careful, proactive observation of the filling level of the tank container is not easily possible due to the area of use or the surrounding environment. This is true of tools used in construction work, for example tampers and vibrating plates for soil compaction, and drilling and/or impact hammers. In agriculture and forestry as well, tools are used that can be provided with a drive system corresponding to the present invention, such as power saws, lawnmowers, and farm machines for use on an uneven ground surface or on steep terrain. In the named tools, reversing starters are often provided, so that the expulsion of air out of the carburetor or out of the fuel lines after the fuel tank has run empty is connected with a high degree of physical exertion. In these and additional tools, with the aid of the present invention the functional impairments and the material damages can be prevented that repeatedly occur due to emptying of the tank containers in what are often rough working conditions. In addition, the present invention can also be used in further tools and can be combined with different forms of the filling level monitoring system.

If, in a further possible variant embodiment, such a tool is additionally equipped with a control device that can monitor and influence the state of the tool, then, in cooperation with the filling level monitoring device and the interruption device, this control device can suitably determine the point in time for an interruption of the engine after the recognition of an imminent lack of expendable operating media. Thus, for example before the interruption of the drive system the tool can be brought into a suitable, for example safe state, in which for example safety valves that may be present are opened, supports are extended, movable parts are set to an idle position, workpieces are made removable, and electrically controlled anchors are detached, so that the tool can also be moved away from the location of use after the interruption of the engine. The later interruption time caused by this however presupposes that the imminent lack of an operating medium is signaled in a timely manner by the filling level monitoring device, so that a time span adequate for these measures can elapse before the interruption of the engine.

In a specific embodiment, such a drive system can have a control device for monitoring and controlling a state of a tool operated by the drive system. If the filling level monitoring device determines that the filling level has sunk below the predetermined filling level, the control device can, as a function of the state of the tool, determine a time for the interruption of the operation of the engine by the interruption device. In addition, the control device can control the interruption of operation by the interruption device at said time. In this way, a time expected to be suitable can be selected for the shutoff, for example with regard to an operating state of the tool.

In a variant of this specific embodiment, the time can be determined by the control device in such a way, and/or the tool can be controlled in such a way, that at said time the tool the tool is expected to be in a state that is operationally safe and/or suitable for maintenance. For example, a time can be sought at which, as stated above, safety valves that may be present in a pressure container are opened, and movable, e.g. oscillating, parts are held still, or arrested. In addition, the state of the tool before the shutoff can be influenced in such a way that at the selected time it is expected to be suitable for the shutoff. Thus, supports of a tool that is for example guided manually during operation can be extended, and flaps or presses can be opened, so that workpieces can for example be removed from a hydraulic press. In addition, an electrically controlled anchoring of the tool can be detached, so that the tool can be moved away from the location of use even after interruption of the engine.

In a further specific embodiment, the time can be determined by the control device in particular in such a way that a material processed by the tool and/or a workpiece processed by the tool is removable and/or is removed from the tool. This can for example make sense in the case of materials that harden during the shutoff phase or that can permanently bond with the tool. Thus, it can make sense to open openings, flaps, and/or valves for the removal of material before the shutoff, and/or to seek an ejection or removal for example by the tool or by an operator. For example, a timely removal of liquid concrete from a concrete mixing installation or a concrete pump can be decisive for the further usability thereof, because after hardening of the concrete the tool would no longer be usable.

In a method for monitoring the filling level of the tank container, the drive system additionally has a control device for monitoring and controlling the state of the tool operated by the drive system. The method further includes a determination of the time for interruption of the operation of the engine by the control device when the filling level monitoring device has determined that the filling level has sunk below the predetermined filling level, the time being determined as a function of the state of the tool. In addition, the method includes a controlling of the interruption of the operation at said time by the control device, for example in accordance with the above description.

In the following, these and additional features of the present invention are explained in more detail on the basis of examples, with the aid of the accompanying Figures.

### BRIEF DESCRIPTION OF THE DRAWINGS

FIG. 1 schematically shows an exemplary embodiment having a fuel tank and a capacitive filling level sensor, in the case of adequate presence of fuel;

FIG. 2 shows the exemplary embodiment shown in FIG. 1 with a too-low filling level of the fuel tank;

FIG. 3 schematically shows an exemplary embodiment having a fuel tank and a reserve fuel tank and having capacitive filling level sensors, in the case of a too-low filling level in the fuel tank;

FIG. 4 schematically shows an exemplary embodiment having a fuel tank and a reserve fuel tank having mechanical filling level sensors that are monitored together, in the case of a too-low filling level in the fuel tank;

FIG. 5 schematically shows an exemplary embodiment having a fuel tank and a reserve fuel tank having capacitive filling level sensors on the feed line system between the tank containers and the engine, in the case of a too-low filling level in the fuel tank; and

FIG. 6 schematically shows an exemplary embodiment of a measurement container having a capacitive filling level sensor.

### DETAILED DESCRIPTION OF THE PREFERRED EMBODIMENT

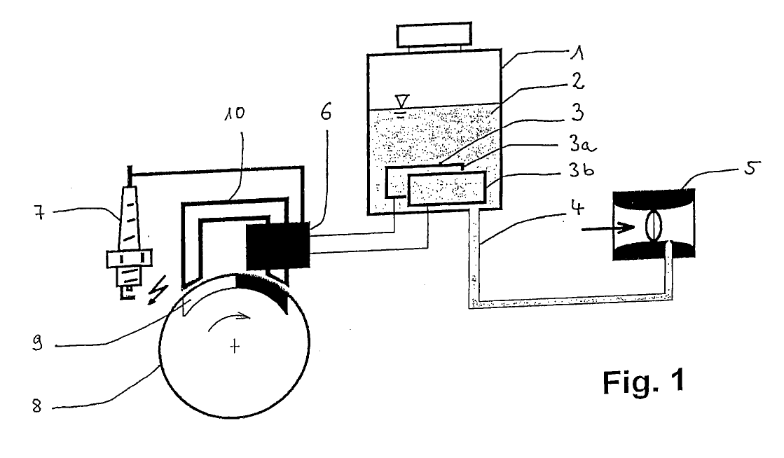

FIG. 1 shows a drive unit according to the present invention in which the filling level of a fuel tank 1 is monitored. Fuel tank 1 is sufficiently filled with fuel 2. In order to measure the filling level, a capacitive sensor 3 is used that has two electrodes 3a and 3b, between which fuel 2 acts as a dielectric, as a function of its filling level. In FIG. 1, the intermediate space between electrodes 3a and 3b is completely filled with fuel 2, which is recognized by capacitive sensor 3. Fuel 2 is supplied via a feed line 4 to a carburetor 5 of an internal combustion engine. Because the manner of operation of an internal combustion engine is known, it is not described in more detail here.

In the exemplary embodiment shown in FIG. 1, the evaluation of the filling level is carried out in a combined filling level monitoring and interruption device 6. Here, the signals of capacitive sensor 3 are evaluated, and when the filling level falls below the predetermined filling level, the further ignition of the drive unit is prevented. For this purpose, the forwarding of the ignition impulse to spark plug 7 is prevented.

The supply of voltage to filling level monitoring and interruption device 6, as well as to spark plug 7, is ensured in the exemplary embodiment shown in FIG. 1 by a system that is known from the area of magnetic ignition systems. For this purpose, a magnet 9, which is fastened to a crankshaft 8 that belongs to the engine or is driven rotationally by crankshaft 8, is moved past a yoke 10, so that a high-voltage pulse is produced. The combined filling level monitoring and interruption device 6 draws energy from yoke 10. This energy is supplied for the operation of the combined filling state monitoring and interruption device 6 and of capacitive sensor 3. If an adequate amount of fuel 2 is present in fuel tank 1, it is further forwarded as an ignition pulse for spark plug 7.

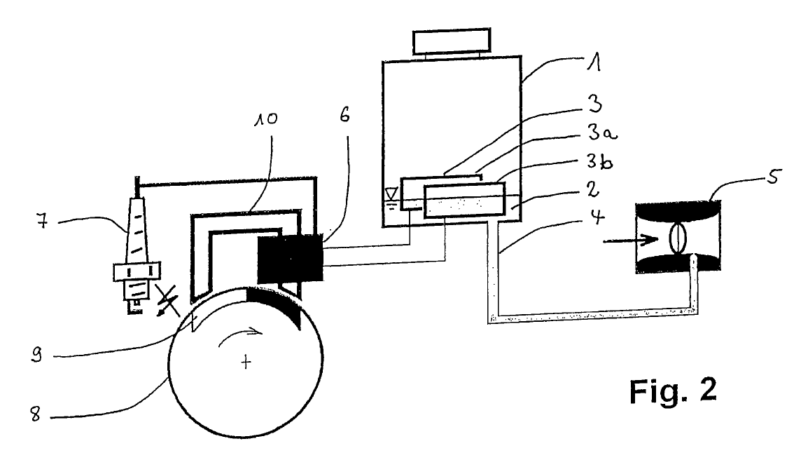

FIG. 2 describes the variant embodiment of the present invention shown in FIG. 1 in the case of a low filling level of fuel 2 in fuel tank 1. When the filling level of fuel 2 sinks, air moves between electrodes 3a and 3b, which is recognized by capacitive sensor 3 and thus by combined filling state monitoring and interruption device 6. This device now prevents the ignition of spark plug 7 and thus interrupts the operation of the internal combustion engine of the drive unit. In the configuration shown in FIG. 2, it can be seen that, due to the situation of electrodes 3a and 3b in the fuel tank 1, a boundary filling level for fuel 2 is predefined, and capacitive sensor 3 recognizes when the filling level sinks below this boundary level.

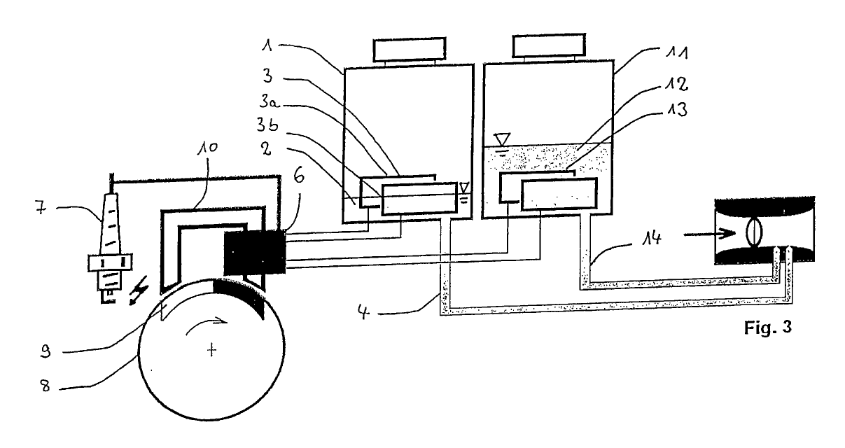

FIG. 3 shows a further variant embodiment of a drive system according to the present invention. Here, in addition to fuel tank 1 a reserve fuel tank 11 is provided in which a fuel reserve 12 is stored for the operation of the engine. In reserve fuel tank 11, the filling level is monitored by a second capacitive sensor 13. Fuel reserve 12 is conducted via a reserve feed line 14 from reserve fuel tank 11 into carburetor 5. Here, the ignition of spark plug 7 by combined filling level monitoring and interruption device 6 remains possible, even though fuel tank 1 has a too-low filling level, because a sufficient fuel reserve 12 is still available in fuel reserve tank 11.

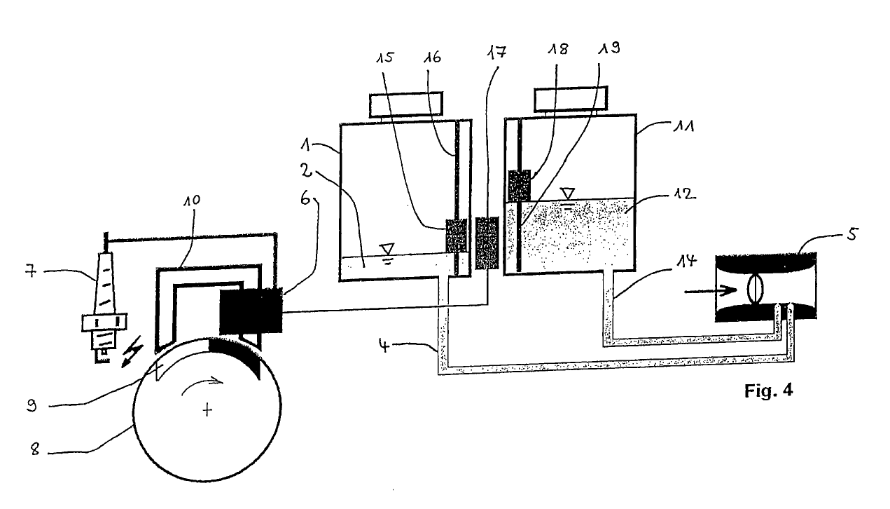

FIG. 4 shows a further possible embodiment of a drive system according to the present invention, in which the filling level is monitored by a mechanical float system. For this purpose, in fuel tank 1 a float system 15 is provided in which the level of fuel 2 is measured via the position of a float 16. A low position of float 16 is caused by a low filling level of fuel 2. The position is recognized by a detector 17 that uses optical or magnetic recognition to recognize the position of float 16 in a predefined region, and signals this position to combined filling level monitoring and interruption device 6. Reserve fuel tank 11 is also equipped with a reserve float 18 on a reserve float system 19, whose position is a result of the filling level of fuel reserve 12. The position of reserve float 18 is also recognized by detector 17 and is signaled to combined filling level and interruption device 6. In FIG. 4 as well, due to the low filling level in fuel tank 1 the ignition of spark plug 7 by the combined filling level monitoring and interruption device is not prevented, because reserve fuel tank 11 still has a sufficient fuel reserve 12.

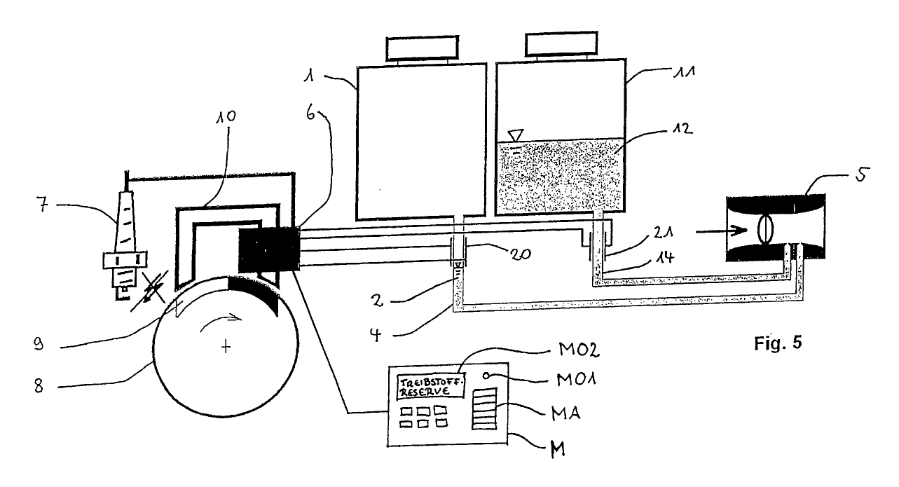

FIG. 5 shows a further embodiment of a drive system according to the present invention in which the filling level of fuel 2 is determined not on or in fuel tank 1 but rather at feed line 4 of fuel tank 1 to carburetor 5. Here there is situated a capacitive line sensor 20 that is dielectrically moderated [sic] by the filling level of the fuel in feed line 4. The filling level of reserve fuel tank 12 is also measured by a second capacitive line sensor 21 on reserve feed line 14 to carburetor 5.

In FIG. 5, the positioning of capacitive line sensor 20 is selected such that a lack of fuel is not recognized until there has been a complete emptying of fuel tank 1 and feed line 4 has begun to empty, but before air can enter into the horizontal segment of feed line 4. For this purpose, capacitive line sensor 20 is situated on the first segment, going out vertically from fuel tank 1, of feed line 4.

In FIG. 5, the ignition of spark plug 7 is first prevented by combined filling level monitoring and interruption device 6 in order to prevent penetration of air into feed line 4. In this way it is achieved that when fuel tank 1 is emptied no air enters into feed line 4 that cannot automatically escape when fuel tank 1 is refilled.

At the same time, an emergency starting function can enable a restarting of the engine using fuel reserve 12 situated in reserve fuel tank 11, in order for example to enable a tool driven by the engine to be moved away in emergency cases. However, here it must be accepted that a resulting suction will cause air to move into feed line 4. Here it is clear that in combined filling level monitoring and interruption device 6 a shutoff logic can be realized that is complex and that can be fashioned as needed.

In addition, in FIG. 5 the positioning of second capacitive line sensor 21 on the first segment, going out vertically from reserve fuel tank 11, of reserve feed line 14 ensures that this reserve feed line is also protected against the penetration of air.

In addition, in FIG. 5 a signaling device M is shown by which optical and/or acoustic messages can be outputted when filling level monitoring device 6 determines that the filling level in fuel tank 1 and/or in reserve tank 11 has sunk below the predetermined filling level and/or below a further predetermined filling level. Signaling device M has for example an acoustic signaling device MA that can be formed as a loudspeaker or buzzer and that can output acoustic signals and/or warning signals corresponding to the recognized filling level. In addition, a first optical signaling device MO1 in the form of a light-emitting diode is provided that can output optical signals and/or warning signals corresponding to the recognized filling level, by lighting, blinking, or changing color. In addition, a further optical signaling device MO2 is provided in which signals regarding the filling level can be outputted as text. In the example, an indication of a use of the reserve tank is shown.

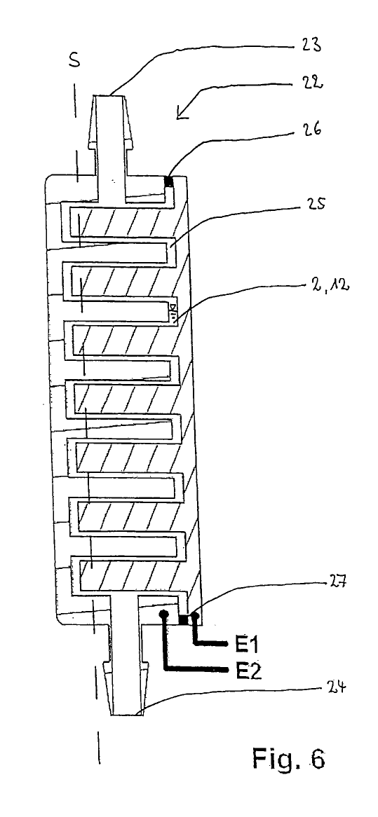

FIG. 6 shows an exemplary embodiment of a measurement container 22 having a capacitive filling level sensor.

Measurement container 22 has an inlet 23 that can be connected to a first part of feed line 4, 14 upstream, i.e. in the direction of connected fuel tank 1 or reserve fuel tank 11. In addition, measurement container 22 has an outlet 24 that can be connected to a second part of feed line 4, 14 downstream. The fuel conducted from fuel tank 1 or from reserve fuel tank 11 through feed lines 4, 14 to carburetor 5 can therefore be conducted through inlet 23 into an internal chamber 25 of the measurement container, through this to outlet 24, and through the second part of feed line 4, 14, to carburetor 5. In this way, fuel 2, 21 flows through internal chamber 25 of measurement container 22.

In addition, measurement chamber 22 has two wall regions E1, E2 that are electrically separated from one another by electrical insulators 26, 27 and that tightly surround internal chamber 25 of measurement container 22. Wall regions E1, E2 are made of electrically conductive material and are fashioned as capacitor plates of a capacitor. In addition, wall regions E1, E2 are connected to a measurement and evaluation unit (not shown) by electrical lines (not shown).

Wall regions E1, E2 are folded into one another in at least two layers along a sectional line S that runs through the measurement container, in such a way that an alternating layering of the two wall regions E1, E2 results with spatial overlapping in the region of sectional line S. In this way there results an angled structure of internal chamber 25 that makes it possible to achieve a small spatial extension of measurement container 22 despite large surfaces of wall regions E1, E2 fashioned as capacitor plates.

As a function of stored fuel 2 or fuel reserve 12, measurement container 22 can have a variable filling level. Fuel 2 or fuel reserve 12, and air that may be present in internal chamber 25, act as a dielectric between wall regions E1, E2, and in this way modulate a capacitance of the capacitor, as a function of the filling level. The filling level of measurement container 22 can therefore be determined through an evaluation of the capacitance, for example using an oscillating circuit (not shown).

At the same time, due to the angled construction of internal chamber 25, vibrations and shaking have only a slight effect on the filling level of the internal chamber, enabling stable measurement even in tools that are exposed to strong accelerations, shaking, and vibrations.

Measurement container 22 can be an integral component of feed line 4 and/or of reserve feed line 14. For example, analogously to the specific embodiment shown in FIG. 5, measurement container 22 can be situated on the first segment, essentially going out vertically from fuel tank 1, of feed line 4, or on the first segment, going out essentially vertically from reserve fuel tank 11, of reserve feed line 14, so that a penetration of air into a part that is difficult to vent of feed line 4 or of reserve feed line 14 is prevented.

In addition, measurement container 22 can be an integral component of combined filling level monitoring and interruption device 6 and can thus be an integral part of an engine electronics assembly. In this way, a wiring outlay can be minimized in the electronic interconnection of the named devices. Because in this design fuel flows through the engine electronics assembly, a suitable configuration of a flow duct is to be provided, which can for example require suitable hose connectors.

1. A drive system comprising:
an engine;
a tank container for storing an expendable operating medium for the engine;
a filling level monitoring device for monitoring the filling level in at least one of the tank container in a feed line from the tank container to the engine; and
an interruption device for interrupting the operation of the engine when the filling level monitoring device determines that the filling level has sunk below a predetermined filling level, wherein the filling level monitoring device has a sensor for monitoring the filling level, the sensor being situated on or in the feed line in such a way that the feed line has a continuous incline from the position of the sensor up to the tank container.

2. The drive system as recited in claim 1, wherein the engine has an ignition device for igniting the engine, and that the interruption device brings about the stopping of the operation of the engine by preventing the ignition of the engine by the ignition device.

3. The drive system as recited in claim 2, wherein at least one of the interruption device and the filling level monitoring device is integrated completely or partly into the ignition device.

4. The drive system as recited in claim 1, wherein a control device for monitoring and controlling a state of a tool operated by the drive system, such that when the filling level monitoring device determines that the filling level has sunk below the predetermined filling level, the control device defines a time for interrupting the operation of the engine as a function of the state of the tool, and controls the interruption of the operation by the interruption device at said time.

5. The drive system as recited in claim 4, wherein, using the control device, the time can be determined and/or the tool can be controlled in such a way that at said time the tool is expected to be in an operationally safe state and/or a state suitable for maintenance.

6. The drive system as recited in claim 4, wherein the time is capable of being determined in such a way that at said time a material being processed by the tool and/or a workpiece being processed by the tool can be removed and/or is removed from the tool.

7. The drive system as recited in claim 1, wherein the filling level monitoring device has a sensor for monitoring the filling level, and that the sensor is a capacitive, optical, magnetic, or thermal sensor that is situated on or in the tank container or on or in the feed line.

8. The drive system as recited in claim 7, wherein the sensor is a capacitive sensor and has two electrodes between which the operating medium acts as a dielectric as a function of its filling level.

9. The drive system as recited in claim 8, wherein a measurement container having an inlet that is connected to a first part of the feed line upstream, and having an outlet that is connected to a second part of the feed line downstream, the electrodes being situated on or in the measurement container.

10. The drive system as recited in claim 9, wherein the electrodes are formed by two wall regions of the measurement container that are electrically insulated from one another, and wherein the wall regions are folded into one another in an alternating fashion in at least two layers, along a sectional line that runs through the measurement container.

11. (canceled)

12. A method for monitoring a filling level of a tank container for storing an expendable operating medium for an engine of a drive system, the drive system having a filling level monitoring device for monitoring the filling level in the tank container and/or in a feed line from the tank container to the engine, and having an interruption device for interrupting the operation of the engine, and the filling level monitoring device having a sensor for monitoring the filling level, the sensor being situated on or in the feed line in such a way that the feed line has a continuous incline from the position of the sensor up to the tank container, wherein evaluation of the filling level of the tank container by the filling level monitoring device; and interruption of the operation of the engine when the filling level monitoring device determines that the filling level has sunk below a predetermined filling level.

13. The method as recited in claim 12, wherein on the basis of the determination that the filling level has sunk below the predetermined filling level and/or below a further predetermined filling level, one or more of the following measures are triggered:
immediate interruption of the operation of the engine;
interruption of the operation of the engine after a predetermined span of time after determination that the filling level has sunk below at least one of the predetermined filling level and the further predetermined filling level;
activation of at least one of an acoustic signal and/or optical signal by a signaling device.

14. The method as recited in claim 12, wherein the drive system has a control device for monitoring and controlling a state of a tool operated by the drive system, the central device determining a time for interruption of the operation of the engine by the control device when the filling level monitoring device determines that the filling level has sunk below the predetermined filling level, the time being determined as a function of the state of the tool; and further comprising controlling the interruption of the operation at said time by the control device.

15. A tool comprising:
a driven element; and
a drive system comprising:
an engine that supplies power to the driven element,
a tank container for storing an expendable operating medium for the engine,
a filling level monitoring device for monitoring the filling level in at least one of the tank container and in a feed line from the tank container to the engine, and
an interruption device for interrupting the operation of the engine when the filling level monitoring device determines that the filling level has sunk below a predetermined filling level, wherein the filling level monitoring device has a sensor for monitoring the filling level, the sensor being situated on or in the feed line in such a way that the feed line has a continuous incline from the position of the sensor up to the tank container.

16. The tool as recited in claim 15, wherein the tool comprises one of:
a tamper for soil compaction,
a vibrating plate for soil compaction,
a drill hammer, and
an impact hammer.
